(19) United States
(12) Patent Application Publication
(10) Pub. No.: US 2026/0081672 A1
(43) Pub. Date: Mar. 19, 2026

(54) BUTLER MATRIX

(71) Applicant: Huawei Technologies Co., Ltd., Shenzhen (CN)

(72) Inventors: Mehri Borhani Kakhki, Kanata (CA); Ahmed Abdellatif, Stittsville (CA); Hari Krishna Pothula, Stittsville (CA); David Neal Wessel, Kanata (CA)

(21) Appl. No.: 19/339,817

(22) Filed: Sep. 25, 2025

Related U.S. Application Data
(63) Continuation of application No. PCT/CN2023/092338, filed on May 5, 2023.

(51) Int. Cl. H04B 7/06

(52) U.S. Cl. CPC H04B 7/06952

(57) ABSTRACT

A Butler matrix includes non-aperture couplers and phase shifters on a first substrate, non-aperture couplers and phase shifters on a second substrate, and a ground plane separating the first substrate from the second substrate. The non-aperture couplers and the phase shifters on the first substrate are connected to the non-aperture couplers and the phase shifters on the second substrate using vias extending from the first substrate to the second substrate and passing through the ground plane. The Butler matrix is a 2^{N}×2^{N} matrix, and N is an integer greater than or equal to 4.

### CROSS-REFERENCE TO RELATED APPLICATION

The present application is a continuation of Patent Cooperation Treaty Application Serial No. PCT/CN2023/092338, entitled “BUTLER MATRIX,” filed on May 5, 2023, the entirety of which is incorporated by reference herein.

### TECHNICAL FIELD

The present disclosure relates to wireless communications and radar systems, and in particular to a Butler matrix.

### BACKGROUND

Beam switching and beam steering are required techniques for communications applications, especially millimeter-wave applications. In this context, a Butler matrix is a popular, passive, beam-switching network with multiple input ports and multiple output ports. By exciting each input port of a Butler matrix, a constant phase difference between adjacent output ports is produced. When the output ports of the Butler matrix are connected to an antenna array, this causes beam tilting towards a specific direction. The number of input ports is equal to the number of output ports, and the Butler matrix is generally expressed as a power of 2 (2^{N} (inputs)×2^{N} (outputs), with N=2, 3, 4, etc.). Typically, at millimeter-wave frequencies, Butler matrices suffer from lower losses compared to phase shifters and Rotman lenses. Butler matrices are also more compact than Rotman lenses.

Butler matrix topology is generally based on interconnected directional couplers, phase shifters, and crossovers. Most publications focus on 4×4 and 8×8 Butler matrix development in which the complexity is relatively low. 16×16 Butler matrix development, however, is inherently more complex. In addition, the relatively high number of crossovers that are required for 16×16 Butler matrices increases the loss, size, and phase error of the system. For example, in a 16×16 Butler matrix having more than 116 components, the number of crossovers is more than 50% of the total number of components.

While attempts have been made to reduce the number of crossovers in a 16×16 Butler matrix, such attempts have also resulted in relatively large 16×16 Butler matrices, making them unsuitable for applications requiring smaller form factors.

### SUMMARY

According to a first aspect of the disclosure, there is provided a Butler matrix comprising: non-aperture couplers and phase shifters on a first substrate; non-aperture couplers and phase shifters on a second substrate; and a ground plane separating the first substrate from the second substrate, wherein: the non-aperture couplers and the phase shifters on the first substrate are connected to the non-aperture couplers and the phase shifters on the second substrate using vias extending from the first substrate to the second substrate and passing through the ground plane; and the Butler matrix is a 2^{N}×2^{N} matrix, wherein N is an integer greater than or equal to 4.

By designing the Butler matrix with non-aperture couplers, components of the Butler matrix may be designed using stripline technology. The use of striplines may allow the Butler matrix to have a relatively smaller form factor than corresponding Butler matrices in the prior art.

At least one non-aperture coupler on the first substrate, or at least one phase shifter on the first substrate, may comprise one or more striplines.

At least one non-aperture coupler on the second substrate, or at least one phase shifter on the second substrate, may comprise one or more striplines.

According to some embodiments, the Butler matrix does not comprise any crossovers. Therefore, transmission lines may be of reduced length which may reduce the insertion loss of the Butler matrix.

N may be equal to 4.

The phase shifters on each of the first and second substrates may define respective first, second, and third rows of phase shifters. Each row of phase shifters may comprise respective first, second, third, and fourth phase shifters. For each of the first and second substrates, each phase shifter of the first row of phase shifters may be configured to provide a phase shift of 45°, the first and third phase shifters of the second row of phase shifters may be configured to provide phase shifts 22.5°, and the second and fourth phase shifters of the second row of phase shifters may be configured to provide phase shifts 67.5°. The first phase shifter of the third row of phase shifters may be configured to provide a phase shift of 56.25°, the second phase shifter of the third row of phase shifters may be configured to provide a phase shift of 33.75°, the third phase shifter of the third row of phase shifters may be configured to provide a phase shift of 11.25°, and the fourth phase shifter of the third row of phase shifters may be configured to provide a phase shift of 78.75°.

According to a further aspect of the disclosure, there is provided a method of making a 2^{N}×2^{N} Butler matrix, comprising: making the 2^{N}×2^{N} Butler matrix by: providing a first substrate on a first side of a ground plane; providing non-aperture couplers and phase shifters on the first substrate; providing a second substrate on a second side of the ground plane; providing non-aperture couplers and phase shifters on the second substrate; connecting the non-aperture couplers and phase shifters on the first substrate with the non-aperture couplers and phase shifters on the second substrate by providing vias extending from the first substrate to the second substrate and passing through the ground plane; and folding the 2^{N}×2^{N} Butler matrix across a fold line extending in a first direction, wherein N is an integer greater than or equal to 4.

The Butler matrix may therefore benefit from a smaller footprint/form factor, allowing the Butler matrix to be more efficiently used with low-frequency bands.

The method may further comprise: further folding the folded Butler matrix across a fold line extending in a second direction different from the first direction.

The second direction may be perpendicular to the first direction.

According to a further aspect of the disclosure, there is provided a beam-steering device comprising: a Butler matrix according to any of the above-described embodiments; an array of antennas connected to outputs of the Butler matrix; and one or more radio-frequency components for providing one or more electromagnetic signals to inputs of the Butler matrix.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a Butler matrix connected to an array of antennas and a switch, according to an embodiment of the disclosure;

FIG. 2A is a schematic diagram of a bilayer 16×16 Butler matrix using non-aperture couplers, according to an embodiment of the disclosure;

FIG. 2B is a cross-sectional view of the Butler matrix of FIG. 2A, according to an embodiment of the disclosure;

FIG. 3 is a circuit diagram of the Butler matrix of FIG. 2A, according to an embodiment of the disclosure;

FIG. 4 is a plot of phase difference as a function of frequency for the Butler matrix of FIG. 2A, according to an embodiment of the disclosure;

FIG. 5A is a schematic diagram of a conventional 4×4 Butler matrix;

FIG. 5B is a plot of simulated transmission coefficient and reflection coefficient for the Butler matrix of FIG. 5A;

FIG. 6A is a schematic diagram of a bilayer 4×4 Butler matrix using non-aperture couplers, according to an embodiment of the disclosure;

FIG. 6B is a plot of simulated transmission coefficient and reflection coefficient for the Butler matrix of FIG. 6A, according to an embodiment of the disclosure;

FIG. 7A is a top view of a folded bilayer 16×16 Butler matrix using non-aperture couplers, according to an embodiment of the disclosure; and

FIG. 7B is a perspective view of the folded bilayer 16×16 Butler matrix of FIG. 7A, according to an embodiment of the disclosure.

### DETAILED DESCRIPTION

The present disclosure seeks to provide novel Butler matrices. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a bilayer Butler matrix comprising non-aperture couplers (such as branch-line hybrid couplers) and phase shifters on a first substrate, and non-aperture couplers (such as branch-line hybrid couplers) and phase shifters on a second substrate. A ground plane separates the first substrate from the second substrate. The non-aperture couplers and the phase shifters on the first substrate are connected to the non-aperture couplers and the phase shifters on the second substrate using vias extending from the first substrate to the second substrate and passing through the ground plane. The Butler matrix is a 2^{N}×2^{N} matrix, wherein N is an integer greater than or equal to 4. For example, with N=4, the above-described Butler matrix is a 16×16 Butler matrix.

Embodiments of the Butler matrix topology described herein may entirely avoid the need for any crossovers. In addition, the size of the Butler matrix may be reduced by up to 75% compared to conventional 16×16 Butler matrices, as described in further detail below.

Embodiments of the Butler matrix topology described may have transmission lines of reduced length. For example, compared to conventional 16×16 Butler matrices, the transmission lines may be reduced in length by 60% to 70%. The reduced length of the transmission lines may reduce the insertion loss of the Butler matrix.

By designing the Butler matrix with non-aperture couplers instead of aperture couplers, components of the Butler matrix may be designed using stripline technology. The use of striplines may allow the Butler matrix to have a relatively smaller form factor than corresponding Butler matrices in the prior art. Butler matrices according to embodiments of the disclosure may therefore be implemented in equipment such as mobile devices or base station antennas operating at millimeter-wave frequencies.

More generally, Butler matrices according to embodiments of the disclosure may be used for any suitable frequency band and for any equipment in need of a beam-switching network, such as wireless communications, imaging, and sensing.

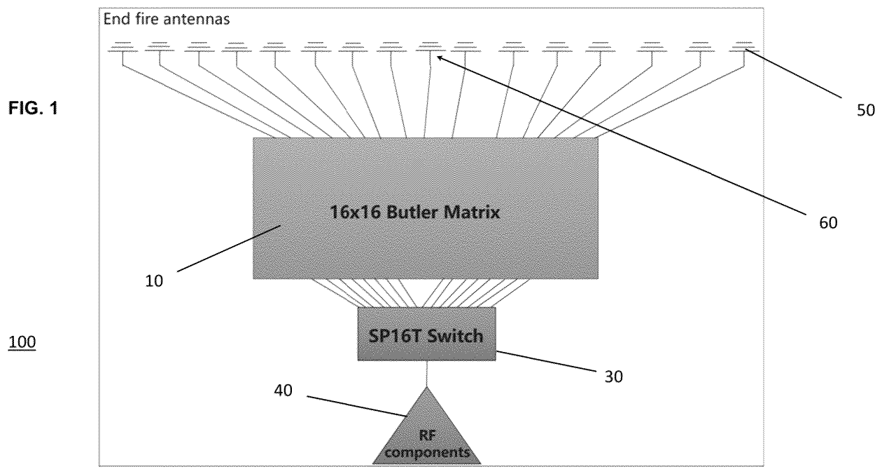

Turning now to FIG. 1, there is shown an example of a 16×16 Butler matrix 10 used in a wireless communications system 100, according to an embodiment of the disclosure. As described above, Butler matrix 10 is a passive, beam-switching network used to steer the beam of an antenna array 60 towards a predefined direction. The output ports of Butler matrix 10 are connected to sixteen end fire antennas 50, and the input ports of Butler matrix 10 are connected to a SP16T switch 30 which is connected to RF components 40. As described above, in a Butler matrix, each input port is able to produce a specific phase difference between two adjacent antennas connected to outputs of the Butler matrix. Therefore, according to the embodiment shown in FIG. 1, SP16T switch 30 is able to excite the input ports of Butler matrix 10 in order that the produced beam be able to be steered by +69°.

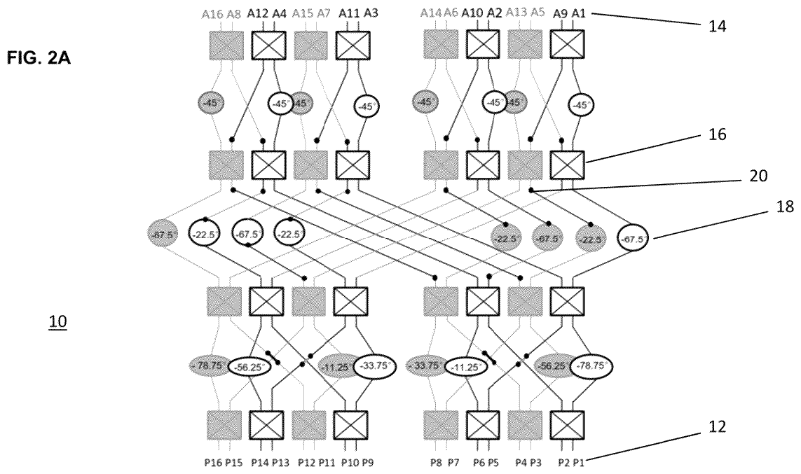

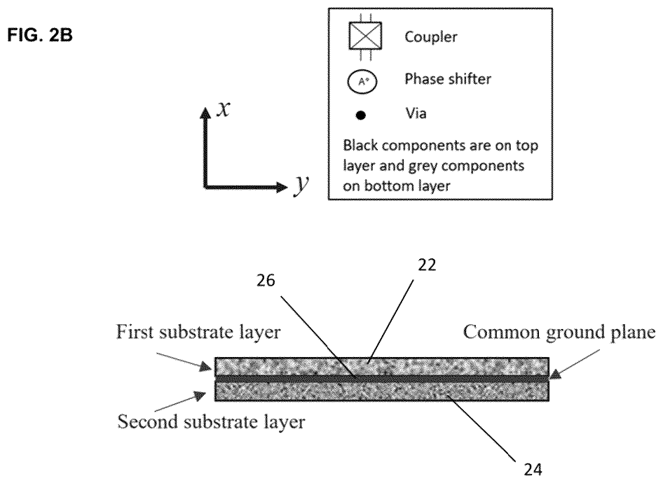

Turning to FIGS. 2A and 2B, there is shown 16×16 Butler matrix 10 in greater detail, according to an embodiment of the disclosure. Butler matrix 10 is implemented on two substrate layers 22 and 24. In FIG. 2A, the black components are printed on top substrate 22, and the grey components are printed on bottom substrate 24. A common ground plane 26 is provided between substrate 22 and 24. The components of Butler matrix 10 include rows of input ports 12, output ports 14, 3 dB non-aperture branch-line hybrid couplers 16, and phase shifters 18. Non-aperture branch-line hybrid couplers 16 produce equal power with 90° phase difference between the outputs of the coupler. The phase shift provided by each phase shifter 18 is indicated in FIG. 2A. According to other embodiments, different non-aperture branch-line hybrid couplers may be used, or different types of non-aperture couplers may be used.

Generally, the components shown in grey are positioned underneath the components shown in black or with a minimum distance separating the lower surface of bottom substrate 24 and the upper surface of top substrate 22. This allows the size of Butler matrix 10 to be reduced. As a result of the topology shown in FIGS. 2A and 2B, a first half of Butler matrix 10 is printed on top of top substrate 22 and the second half of Butler Matrix 10 is printed on top of bottom substrate 24. In addition, as can be seen in FIG. 2A, the transmission lines X on top and bottom substrates 22, 24 are connected using vias 20 extending between top and bottom substrates 22, 24 and through ground plane 26.

Furthermore, as a result of the topology shown in FIGS. 2A and 2B, all crossovers are removed and the size of Butler matrix 10 is reduced by up to half compared to a conventional 16×16 Butler matrix. Further still, as described above, the relative lengths of the transmission lines are reduced, resulting in lower system losses. And further still, as also described above, the use of non-aperture couplers allows the components on both substrates 22, 24 to be implemented using striplines. Butler matrix 10 may therefore benefit from a smaller footprint/form factor, allowing Butler matrix 10 to be more efficiently used with low-frequency bands.

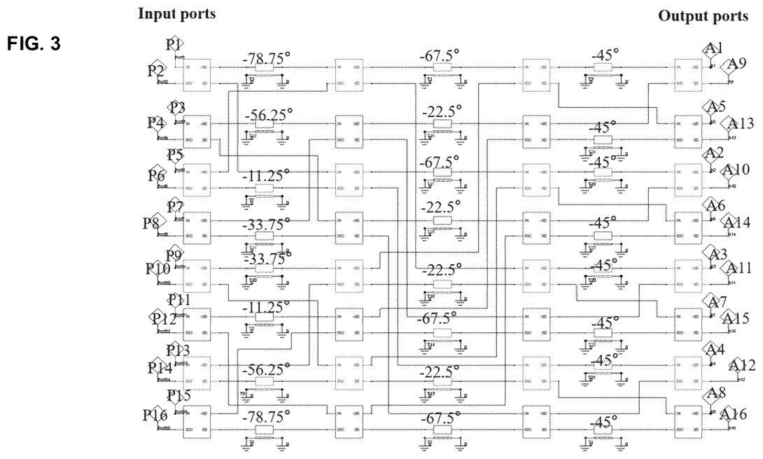

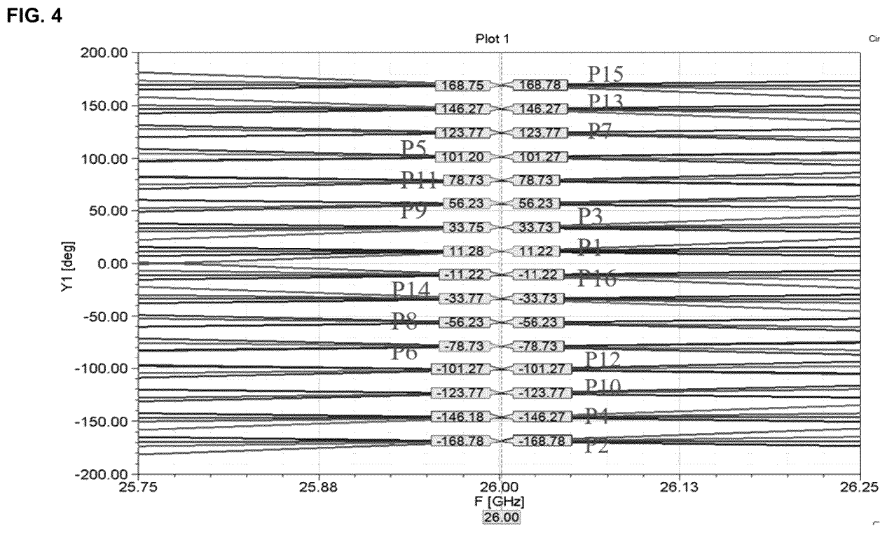

The topology shown in FIG. 2A was validated by designing an electronic circuit of Butler matrix 10, as shown in FIG. 3. FIG. 4 shows the progressive phase difference between adjacent output ports of the electronic circuit in FIG. 3. The phase and beam direction associated with each input port of the electronic circuit in FIG. 3 are shown in Table I.

TABLE I

| | P-1 | P-15 | P-12 | P-6 | P-8 | P-7 | P-4 | P-3 |
|---|---|---|---|---|---|---|---|---|
| Δφ | 11.25 | 168.75 | −101.25 | −78.75 | −56.25 | 123.75 | −146.25 | 33.75 |
| Beam angle | −3.58 | −69.64 | 34.22 | 25.94 | 18.2 | −43.43 | 54.34 | −10.81 |
| (d = 0.5*λ) | | | | | | | | |

| | P-14 | P-13 | P-10 | P-9 | P-11 | P-5 | P-2 | P-16 |
|---|---|---|---|---|---|---|---|---|
| Δφ | −33.75 | 146.25 | −123.75 | 56.25 | 78.75 | 101.25 | −168.75 | −11.25 |
| Beam angle | 10.81 | −54.34 | 43.43 | −18.2 | −25.94 | −34.22 | 69.64 | 3.58 |
| (d = 0.5*λ) | | | | | | | | |

d is the spacing between antenna elements and Δφ is the progressive phase difference produced between adjacent output ports for each input port excitation.

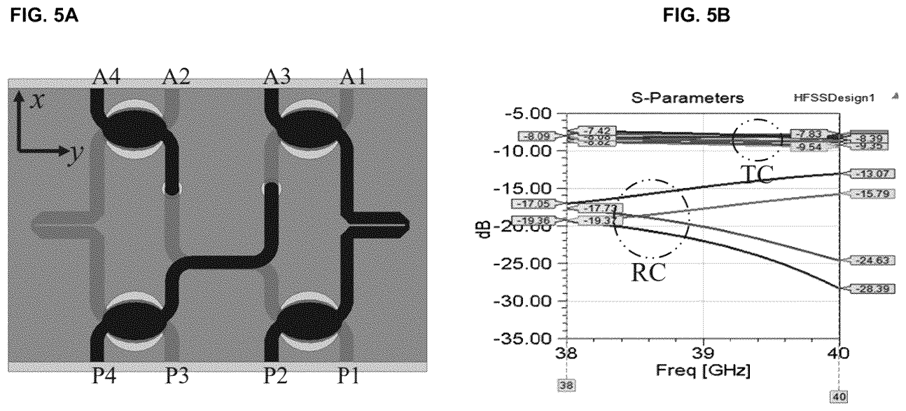

To test the performance of the topology in FIG. 2A, two 4×4 Butler matrices were designed. The first design was a 4×4 Butler matrix employing aperture couplers (FIG. 5A) while the second design used a 4×4 Butler matrix based on the topology presented in FIG. 2A (i.e. using non-aperture couplers). For both designs, the operating frequency band was 38-40 GHz. Both designs included bilayer substrates and therefore all crossovers were removed. In addition, vias were used in both designs to connect transmission lines on the first substrate to transmission lines on the second substrate.

In the Butler matrix presented in FIG. 5A, because of the use of aperture couplers, it was not possible to implement the design using stripline technology. In addition, due to the existence of apertures in the ground plane, the couplers were placed relatively far from each other to avoid coupling effects between them.

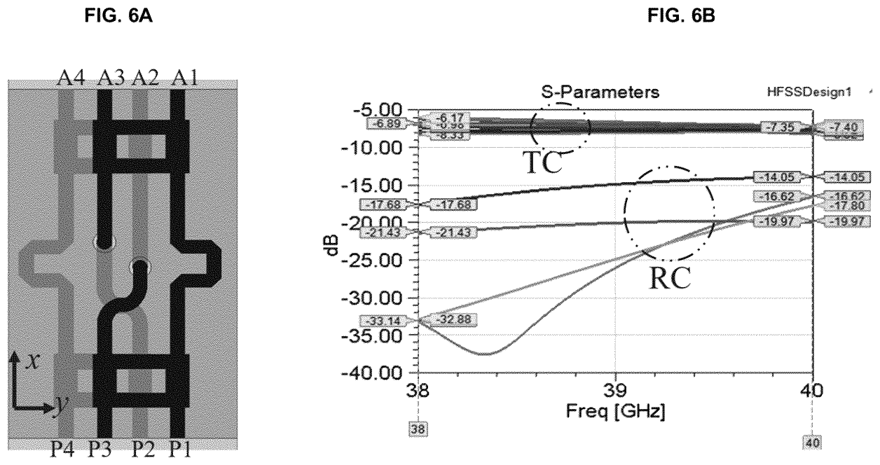

The results of the comparison are shown in Table II. Based on FIGS. 6A and 6B, it can be seen that, using the topology presented in FIG. 2A, the size of the Butler matrix and its insertion loss were reduced by almost half and by 1 dB, respectively.

TABLE II

| | | | | Implementable |
|---|---|---|---|---|
| | Size | Insertion | Return | based on |
| | (mm) | loss | loss | stripline |
| Multilayer 4 × 4 BM | 12 × 8.4 | 2.5 ± 1 | <−13 | No |
| (FIG. 5A) using | | dB | dB | |
| aperture couplers | | | | |
| 4 × 4 multilayer BM | 6 × 10 | 1.5 ± 1 | <−14 | Yes |
| using non-aperture | | dB | dB | |
| couplers (FIG. 6A) | | | | |

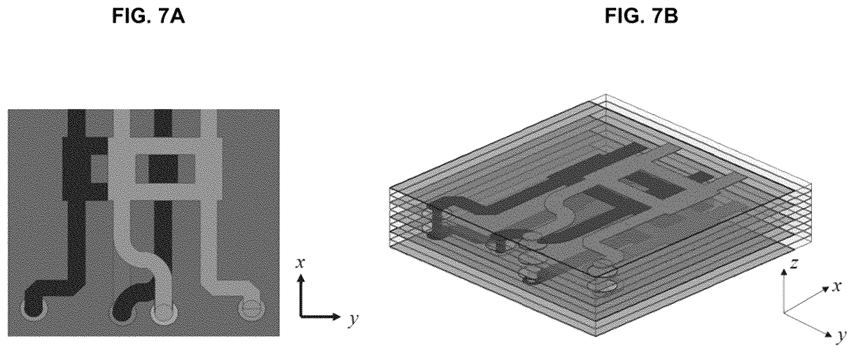

According to some embodiments, Butler matrix 10 presented in FIG. 2A can be further reduced in size by folding Butler matrix 10 across the middle in the y-direction. As can be seen in FIGS. 7A and 7B, the size of folded Butler matrix 10 may be further reduced by further folding Butler matrix 10 across the middle in the x-direction (i.e. where the middle row of −67.5 and −22.5 degree phase shifters are located. The resulting twice-folded structure is shown in FIGS. 7A and 7B. This may be particularly useful for Butler matrices that operate at low frequency bands and that conventionally are large in size.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A Butler matrix comprising:
first non-aperture couplers and first phase shifters on a first substrate;
second non-aperture couplers and second phase shifters on a second substrate; and
a ground plane separating the first substrate from the second substrate,
wherein:
the first non-aperture couplers and the first phase shifters on the first substrate are connected to the second non-aperture couplers and the second phase shifters on the second substrate using vias extending from the first substrate to the second substrate and passing through the ground plane; and
the Butler matrix is a 2N×2N matrix, wherein N is an integer greater than or equal to 4.

2. The Butler matrix of claim 1, wherein at least one non-aperture coupler of the first non-aperture couplers on the first substrate, or at least one phase shifter of the first phase shifters on the first substrate, comprises one or more striplines.

3. The Butler matrix of claim 1, wherein at least one non-aperture coupler of the second non-aperture couplers on the second substrate, or at least one phase shifter of the second phase shifters on the second substrate, comprises one or more striplines.

4. The Butler matrix of claim 1, wherein the Butler matrix does not comprise any crossovers.

5. The Butler matrix of claim 1, wherein N is equal to 4.

6. The Butler matrix of claim 5, wherein:
respective phase shifters on each of the first substrate and the second substrate define respectively a first row of phase shifters, a second row of phase shifters, and a third row of phase shifters, each row of the first row, the second row, and the third row comprising respectively a first phase shifter, a second phase shifter, a third phase shifter, and a fourth phase shifter;
and, for each of the first substrate and the second substrate:
each phase shifter of the first row is configured to provide a phase shift of 45°;
the first phase shifter and the third phase shifter of the second row are configured to provide phase shifts of 22.5°, and the second phase shifter and the fourth phase shifter of the second row are configured to provide phase shifts of 67.5°; and
the first phase shifter of the third row is configured to provide a phase shift of 56.25°, the second phase shifter of the third row is configured to provide a phase shift of 33.75°, the third phase shifter of the third row is configured to provide a phase shift of 11.25°, and the fourth phase shifter of the third row is configured to provide a phase shift of 78.75°.

7. The Butler matrix of claim 1, wherein the Butler matrix is folded along a fold line extending in a first direction.

8. The Butler matrix of claim 7, wherein the Butler matrix is folded along a further fold line extending in a second direction different from the first direction.

9. The Butler matrix of claim 8, wherein the second direction is perpendicular to the first direction.

10. A method comprising:
making a 2^{N}×2^{N} Butler matrix including:
providing a first substrate on a first side of a ground plane;
providing first non-aperture couplers and first phase shifters on the first substrate;
providing a second substrate on a second side of the ground plane;
providing second non-aperture couplers and second phase shifters on the second substrate;
connecting the first non-aperture couplers and the first phase shifters on the first substrate with the second non-aperture couplers and the second phase shifters on the second substrate by providing vias extending from the first substrate to the second substrate and passing through the ground plane; and
folding the 2^{N}×2^{N} Butler matrix across a fold line extending in a first direction into a folded Butler matrix,
wherein N is an integer greater than or equal to 4.

11. The method of claim 10, further comprising:
further folding the folded Butler matrix across a further fold line extending in a second direction different from the first direction.

12. The method of claim 11, wherein the second direction is perpendicular to the first direction.

13. The method of claim 10, wherein at least one non-aperture coupler of the first non-aperture couplers on the first substrate, or at least one phase shifter of the first phase shifters on the first substrate, comprises one or more striplines.

14. The method of claim 10, wherein at least one non-aperture coupler of the second non-aperture couplers on the second substrate, or at least one phase shifter of the second phase shifters on the second substrate, comprises one or more striplines.

15. The method of claim 10, wherein the making the 2^{N}×2^{N} Butler matrix does not comprise using any crossovers.

16. The method of claim 10, wherein N is equal to 4.

17. The method of claim 16, wherein:
respective phase shifters on each of the first substrate and second substrate define respectively a first row of phase shifters, a second row of phase shifters, and a third row of phase shifters, each row of the first row, the second row, and the third row comprising respectively a first phase shifter, a second phase shifter, a third phase shifter, and a fourth phase shifter;
and, for each of the first substrate and the second substrate:
each phase shifter of the first row is configured to provide a phase shift of 45°;
the first phase shifter and the third phase shifter of the second row are configured to provide phase shifts of 22.5°, and the second phase shifter and the fourth phase shifter of the second row are configured to provide phase shifts of 67.5°; and
the first phase shifter of the third row is configured to provide a phase shift of 56.25°, the second phase shifter of the third row is configured to provide a phase shift of 33.75°, the third phase shifter of the third row is configured to provide a phase shift of 11.25°, and the fourth phase shifter of the third row is configured to provide a phase shift of 78.75°.

18. A beam-steering device comprising:
a Butler matrix comprising:
first non-aperture couplers and first phase shifters on a first substrate;
second non-aperture couplers and second phase shifters on a second substrate; and
a ground plane separating the first substrate from the second substrate,
wherein:
the first non-aperture couplers and the first phase shifters on the first substrate are connected to the second non-aperture couplers and the second phase shifters on the second substrate using vias extending from the first substrate to the second substrate and passing through the ground plane; and
the Butler matrix is a 2^{N}×2^{N} matrix, wherein N is an integer greater than or equal to 4;
an array of antennas connected to outputs of the Butler matrix; and
one or more radio-frequency components for providing one or more electromagnetic signals to inputs of the Butler matrix.

19. The beam-steering device of claim 18, wherein at least one non-aperture coupler of the first non-aperture couplers on the first substrate, or at least one phase shifter of the first phase shifters on the first substrate, comprises one or more striplines.

20. The beam-steering device of claim 18, wherein at least one non-aperture coupler of the second non-aperture couplers on the second substrate, or at least one phase shifter of the second phase shifters on the second substrate, comprises one or more striplines.
